(19) United States
(12) Patent Application Publication
(10) Pub. No.: US 2023/0273372 A1
(43) Pub. Date: Aug. 31, 2023

(54) FIBER OPTIC TERMINALS HAVING OPTICAL SPLITTER AND WAVELENGTH DIVISION MULTIPLEXING DEVICES

(71) Applicant: CORNING RESEARCH & DEVELOPMENT CORPORATION, Corning, NY (US)

(72) Inventors: Leydys Deniss De Jesus, Huntersville, NC (US); Dong Gui, San Jose, CA (US); Mark Philip Hess, De Forest, WI (US); Joseph Clinton Jensen, Lawndale, NC (US); Lee Alexander Webb, Huntersville, NC (US)

(21) Appl. No.: 18/142,295

(22) Filed: May 2, 2023

Related U.S. Application Data
(63) Continuation of application No. PCT/US21/57708, filed on Nov. 2, 2021.
(60) Provisional application No. 63/112,899, filed on Nov. 12, 2020.

(51) Int. Cl. G02B 6/293

(52) U.S. Cl. CPC G02B 6/29382; G02B 6/29395; G02B 6/29398

(57) ABSTRACT

Field-configurable optical devices and methods are disclosed. In one example, a field-configurable optical device includes a housing defining an enclosure, an input port located at the housing, a pass-through port located at the housing, a plurality of output ports located at the housing, a splitter disposed within the enclosure, a plurality of couplers within the enclosure, each coupler including an input, a first output, and a second output. Each coupler has a power splitting ratio between the first output and the second output that is different from the other couplers. An input port fiber optic jumper assembly within the enclosure. A pass-through port fiber optic jumper assembly is within the enclosure. Moving the input port fiber optic jumper assembly and the pass-through port fiber optic jumper assembly from a first coupler to a second coupler of the plurality of couplers changes the power splitting ratio of the field-configurable optical device.

### CROSS-REFERENCES TO RELATED APPLICATIONS

This application is a continuation of International Application No. PCT/US21/57708 filed Nov. 2, 2021, which claims the benefit of priority of U.S. Provisional Application Ser. No. 63/112,899 filed on Nov. 12, 2020, the content of which is relied upon and incorporated herein by reference in its entirety.

### FIELD

The present disclosure is directed to fiber optic terminal devices and, more particularly, to compact fiber optic terminal devices for providing optical telecommunication service to a plurality of subscribers by employing various combinations of optical splitter devices and wavelength division multiplexing.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent. To address this need for making quick, reliable, and robust optical connections in communication networks, hardened fiber optic connectors such as the OptiTap® plug connector sold by Corning Optical Communications of Charlotte, N.C. were developed.

Multiports were also developed for making an optical connections with hardened connectors such as the OptiTap. Prior art multiports have a plurality of receptacles mounted through a wall of the housing for protecting an indoor connector inside the housing that makes an optical connection to the external hardened connector of the branch or drop cable.

A conventional fiber optic multiport configured to make optical connections with hardened connectors such as OptiTap (e.g., OptiSheath® sold by Corning Optical Communications) has an input fiber optic cable carrying one or more optical fibers to indoor-type connectors inside a housing. The multiport receives the optical fibers into housing and distributes the optical fibers to receptacles for connection with a hardened connector. The receptacles are separate assemblies attached through a wall of a housing of the multiport. The receptacles allow mating with hardened connectors attached to drop or branching cables (not shown) such as drop cables for “fiber-to-the-home” applications. During use, optical signals pass through the branch cables, to and from the fiber optic cable by way of the optical connections at the receptacles of the multiport. The fiber optic cable may also be terminated with a fiber optic connector. Multiports allowed quick and easy deployment for optical networks.

Although, the housing of prior art multiports are rugged and weatherable for outdoor deployments, the housings of such multiports are relatively bulky for mounting multiple receptacles for the hardened connector on the housing. Consequently, the housing of the multiport is excessively bulky. For example, the multiport may be too boxy and inflexible to effectively operate in smaller storage spaces, such as the underground pits or vaults that may already be crowded. Furthermore, having all of the receptacles on the housing requires sufficient room for the drop or branch cables attached to the hardened connectors attached to the multiport. While pits can be widened and larger storage containers can be used, such solutions tend to be costly and time-consuming. Network operators may desire other deployment applications for multiports such as aerial, in a pedestal or mounted on a façade of a building that are not ideal for the prior art multiports for numerous reasons such as congested poles or spaces or for aesthetic concerns.

Optical communication networks commonly employ a daisy-chain architecture, where an optical signal is sequentially tapped-off at access points along a distribution cable. At each access point, the optical signal is split such that a percentage of the optical signal is split amongst subscribers and another percentage is provided further downstream to the next access point. Splitters (also referred to as couplers) having different splitting ratios are used to split the optical signal. For example, splitters in a daisy-chain may have 90%/10% (i.e., 10% of the signal provided to a plurality of subscribers and 90% provided to the next coupler) 80%/20%, 70%/30%, and 60%/40% splitting ratios.

Consequently, there exists an unresolved need for multiports that allow flexibility for the network operators to customize optical split ratios and quickly and easily make optical connections in their optical network while also addressing concerns related to limited space, organization, or aesthetics.

### SUMMARY

The present disclosure is directed to fiber optic terminals including various combinations of optical splitter devices and wavelength division multiplexing devices in a compact package.

One aspect of the disclosure is directed to a fiber optic terminal including a shell defining a cavity, an input connection port including a port opening extending from an outer surface of the shell into the cavity, a pass-through output connection port including a port opening extending from the outer surface of the shell into the cavity, and at least two output connection ports including a port opening extending from the outer surface of the shell into the cavity. The input connection port, the at least two output connection ports, and the pass-through output connection port are arranged in an array at an edge of the shell. The fiber optic terminal is configured such that an optical power at the pass-through output connection port is greater than an optical power of the at least two output connection ports.

Another aspect of the disclosure is directed to a fiber optic terminal including a shell defining a cavity, an input connection port including a port opening extending from an outer surface of the shell into the cavity, a first splitter device, and a second splitter device. The first splitter device includes a first optical input configured to be optically coupled to an input optical connector inserted into the input connection port, and a splitter optical output and a pass-through optical output. The first splitter device splits an input optical signal received at the first optical input into a first splitter optical output signal at the splitter optical output and a pass-through optical output signal at the pass-through optical output. The second splitter device includes a second optical input optically coupled to the splitter optical output of the first splitter device, and at least two second optical outputs. The second splitter devices splits the first splitter optical signal into at least two second optical output signals at the at least two second optical outputs. The fiber optic terminal further includes a pass-through output connection port and at least two output connection ports. The pass-through output connection port includes a port opening extending from the outer surface of the shell into the cavity and optically coupled to the pass-through optical output of the first splitter device. The pass-through optical output of the first splitter device is configured to be optically coupled to a pass-through connector inserted into the pass-through output connection port. The at least two output connection ports include a port opening extending from the outer surface of the shell into the cavity and optically coupled to the at least two second optical outputs of the second splitter device. The at least two second optical outputs are configured to be optically coupled to at least two output connectors inserted into the at least two output connection ports. The input connection port, the at least two output connection ports, and the pass-through output connection port are arranged in an array at an edge of the shell.

Still another aspect of the disclosure is directed to a fiber optic terminal including a shell defining a cavity, a first input connection port and a second input connection port each including a port opening extending from an outer surface of the shell into the cavity, and an optical coupler within the cavity including a first input operable to receive a first optical signal from the first input connection port, and a second input operable to receive a second optical signal from the second input connection port. The fiber optic terminal further includes a wavelength division demultiplexer device within the cavity including a demultiplexer input that is optically coupled to the coupler output of the optical coupler, and at least two demultiplexer outputs. Each of the at least two demultiplexer outputs is configured to pass an output optical signal in a different wavelength band than the other of the at least two demultiplexer outputs. The fiber optic terminal further includes at least two output connection ports including a port opening extending from the outer surface of the shell into the cavity, wherein the at least two output connection ports receive at least two output optical signals from the wavelength division demultiplexer device.

Still another aspect of the disclosure is directed to a fiber optic terminal including a shell including a cavity, at least two input connection ports including a port opening extending from an outer surface of the shell into the cavity, and at least two splitters within the cavity and each configured to split an input optical signal received at the at least two input connection ports. The fiber optic terminal further includes at least two wavelength division multiplexer devices within the cavity and each configured to receive output optical signals from the at least two splitters and multiplex the output optical signals into at least two multiplexed output optical signals, and at least two output connection ports including a port opening extending from the outer surface of the shell into the cavity. The at least two output connection ports receive the least two multiplexed output optical signals.

Still another aspect of the disclosure is directed to a fiber optic terminal including a shell defining a cavity, a first input connection port and a second input connection port. Each of the first input connection port and the second input connection port include a port opening extending from an outer surface of the shell into the cavity. The fiber optic terminal further includes a first splitter and a second splitter within the cavity, wherein each of the first splitter and the second splitter includes an input, a first splitter output, and a second splitter output. The fiber optic terminal also includes a first wavelength division multiplexer device and a second wavelength division multiplexer device within the cavity, wherein each of the first and second wavelength division multiplexer devices includes a first multiplexer input, a second multiplexer input, and a multiplexer output. The fiber optic terminal also includes at least two output connection ports including a port opening extending from the outer surface of the shell into the cavity. The at least two output connection ports receive at least two output optical signals from the first and second wavelength division multiplexer devices. The first splitter output of the first splitter is optically coupled to the first multiplexer input of the first wavelength division multiplexer device. The second splitter output of the first splitter is optically coupled to the first multiplexer input of the second wavelength division multiplexer device. The first splitter output of the second splitter is optically coupled to the second multiplexer input of the first wavelength division multiplexer device. The second splitter output of the second splitter is optically coupled to the second multiplexer input of the second wavelength division multiplexer device.

Still another aspect of the disclosure is directed to a fiber optic terminal including a shell defining a cavity, a common demultiplexer connection port including a port opening extending from an outer surface of the shell into the cavity, a wavelength division demultiplexer device including a demultiplexer input and a plurality of demultiplexer outputs, wherein the demultiplexer input is optically coupled to the common demultiplexer connection port, and a plurality of output channel connection ports. Each output channel connection port includes a port opening extending from the outer surface of the shell into the cavity, and the plurality of output channel connection ports is optically coupled to the plurality of demultiplexer outputs. The common demultiplexer connection port and the plurality of output channel connection ports are arranged in an array at an edge of the shell.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 illustrates an example fiber optic terminal according to one or more embodiments described and illustrated herein;

FIG. 2A illustrates internal components of an example four output fiber optic terminal according to one or more embodiments described and illustrated herein;

FIG. 2B illustrates an edge of the example four output fiber optic terminal of FIG. 2A according to one or more embodiments described and illustrated herein;

FIG. 2C illustrates six four output fiber optic terminals having different optical power split ratios according to one or more embodiments described and illustrated herein;

FIG. 3A illustrates internal components of an example two output fiber optic terminal according to one or more embodiments described and illustrated herein;

FIG. 3B illustrates an edge of the example two output fiber optic terminal of FIG. 3A according to one or more embodiments described and illustrated herein;

FIG. 3C illustrates six two output fiber optic terminals having different optical power split ratios according to one or more embodiments described and illustrated herein;

FIG. 4A illustrates internal components of another example four output fiber optic terminal according to one or more embodiments described and illustrated herein;

FIG. 4B illustrates an edge of the example four output fiber optic terminal of FIG. 4A according to one or more embodiments described and illustrated herein;

FIG. 4C illustrates six four output fiber optic terminals having different optical power split ratios according to one or more embodiments described and illustrated herein;

FIG. 5A illustrates internal components of an example eight output fiber optic terminal according to one or more embodiments described and illustrated herein;

FIG. 5B illustrates an edge of the example eight output fiber optic terminal of FIG. 5A according to one or more embodiments described and illustrated herein;

FIG. 5C illustrates six eight output fiber optic terminals having different optical power split ratios according to one or more embodiments described and illustrated herein;

FIG. 6 illustrates internal components of an example fiber optic terminal including a wavelength division demultiplexer device and a wavelength division multiplexer device according to one or more embodiments described and illustrated herein;

FIG. 7 illustrates edges of two example daisy-chained fiber optic terminals including at least a wavelength division demultiplexer device according to one or more embodiments described and illustrated herein;

FIG. 8 illustrates an edge of an example fiber optic terminal including at one a wavelength division demultiplexer device and a multi-fiber output port according to one or more embodiments described and illustrated herein;

FIG. 9 illustrates an example optical communications network including an example fiber optic terminal including both an optical coupler and a wavelength division demultiplexer device according to one or more embodiments described and illustrated herein; and

FIG. 10 illustrates an example optical communications network including an example fiber optic terminal including two splitter devices and two wavelength division multiplexer devices.

### DETAILED DESCRIPTION

Reference will now be made in detail to the embodiments of the disclosure, examples of which are illustrated in the accompanying drawings. Whenever possible, like reference numbers will be used to refer to like components or parts.

Embodiments of the present disclosure are directed to fiber optic terminals having a small, compact footprint, a plurality of connection ports with securing features, and multiple combinations of optical components, such as optical splitters and wavelength division multiplexing devices to provide telecommunication services to multiple subscribers.

Optical communication networks rely on optical fiber cables to communicate data by way of optical signals. Fiber cable installation in sparsely populated rural areas is an especially expensive undertaking. Long lengths of fiber optic cable serve a small population. The cable material and installation costs are divided by a low population of end-users. Therefore, an architecture which maximizes the number of users served by each fiber strand in the distribution cable may be attractive. Increasing the number of users that can be served by each fiber strand allows the material and installation costs to be divided among that many more users.

A daisy-chained tap fiber to the x (FTTx) in an optical communication network is a common solution for optical communication network installation, such as those in rural areas. An optical line termination launches a high-power optical signal into a single fiber strand of a multifiber distribution cable. For example, a first 1×2 optical splitter splits the high-power optical signal into a first optical signal that is 98% of the power of the high-power optical signal that is passed to a next optical splitter.

A plurality of asymmetric 1×2 optical splitters (also known as optical tap couplers) are inserted along the length of a given fiber strand of the distribution cable to tap-off a portion of the optical power to feed sets of users along the length of the distribution cable.

Generally, the power tapped off at each tap point is less than 50% and the power that continues downstream on the distribution cable is greater than 50%. Due to the uneven distribution of power between the two optical splitter output ports, the optical splitters are referred to as “asymmetric couplers” or “unbalanced couplers.” However, it should be understood that a 50%/50% 1×2 optical splitter may be used.

Note that the distribution of the optical power between the two output ports of the optical splitters is most unbalanced at the first drop point and gradually approaches a more balanced distribution at the last tap coupler in the chain. This is because the minimum power required by each of the sets of users along the chain is identical; however the total optical power available in the chain is gradually being siphoned off at each subsequent optical splitter/tap point as the daisy-chain progresses downstream. As a result, each subsequent optical splitter/tap point in the daisy-chain needs to tap-off a larger percentage of the total power in order to keep the power to the end nodes constant.

The tapped optical signal exiting the optical splitter is then split again to be evenly provided to individual users. For example, the 10% optical signal is split again and provided to individual users. The optical splitters may be provided in a multiport device that includes not only a 1×2 optical splitter, but also an N×M optical splitter. For example, an eight output multiport device may utilize a 1×8 optical splitter to split the 10% optical signal eight ways. Fiber optic cable assemblies are connected to the output ports of the multiport device and delivered to individual users.

Each optical splitter has a tolerance on maximum loss due to changes in loss over the range of optical wavelengths used in the system, aging, manufacturing tolerances and environmental factors such as temperature. The splitting ratio and/or optical loss may vary as a result of any of these factors. An optical budget is calculated for each end node considering the worst-case loss for each optical splitter. Being that the total optical budget available is a given, any additional dB that needs to be subtracted from the total budget due to large tolerances of the components will result in compromises on the allowable number of drop points along the daisy-chain.

For example, using very tightly tolerance components which maintain an almost constant loss (even over wavelength and environmental conditions) may afford up to six drop points. At the other extreme, components with losses that vary greatly over temperature and wavelength may only allow three drop points along the chain. Thus, optical splitters which can maintain a constant and predictable low loss over temperature, wavelength and environmental stresses are best positioned to deliver the most drop points along the daisy chain.

Therefore, there is value in using optical splitter components which have tighter tolerances to maximize the number of attainable drop points for a given optical budget. This tradeoff between number of attainable drop points and tolerances of components should ideally be optimized to attain the best combination.

Wavelength division multiplexing is another technology utilized in optical communications networks to split an optical signal into multiple optical signals that are then routed to multiple subscribers. In wavelength division multiplexing, an optical signal having a plurality of wavelengths is provided by a telecommunications device, such as at a central office. An enclosure receives the optical signal and a wavelength division demultiplexer within the enclosure divides the optical signal into a plurality of output signals that each have a different wavelength. These output signals are then routed to a plurality of subscribers. To communicate in the opposite direction, a plurality of input signals are received from the plurality of subscribers, and multiplexed by a wavelength multiplexer device in the enclosure into a single upload signal having a plurality of wavelengths.

It should be understood that the terms “multiplexer” and “demultiplexer” are used for ease of description by describing the functionality in one direction of optical transmission. However, the term “multiplexer” is meant to include “demultiplexer” and vice-versa when the embodiment provides optical communication in two directions. For example, a multiplexer device may multiplex within a first wavelength range in a first transmission direction but demultiplex for a second wavelength range in a second transmission direction.

However, present fiber optical terminals including optical splitters are bulky and require a significant footprint. Further, wavelength multiplexing devices are provided in separate enclosures. Providing multiple terminals and enclosures is undesirable because space is often limited.

Various embodiments of fiber optic terminals including combinations of optical splitter devices and wavelength division multiplexing devices are described in detail below.

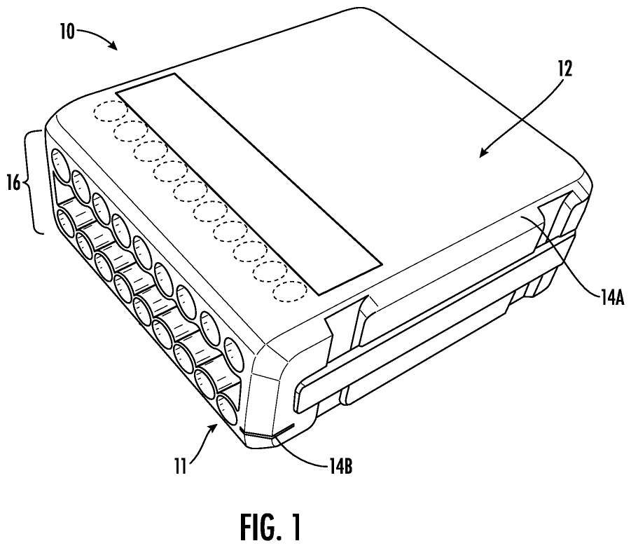

Referring now to FIG. 1, a non-limiting example of a fiber optic terminal 10 is illustrated.

The fiber optic terminal 10 comprises a shell 12 defining an interior cavity in which the internal components are disposed. The shell 12 may be defined by two half-shells, such as an upper shell 14A and a lower shell 14B, for example. The shell 12 defines an edge 11 having an array of connection ports 16 that are defined by an opening extending into a cavity of the fiber optic terminal 10. The connection ports 16 may be configured for receiving external optical connectors or one or more connection ports for receiving fiber optic cables through an edge 11 of the fiber optic terminal 10 and into the cavity of the fiber optic terminal. The connection ports 16 may include any suitable mating mechanism or geometry for securing the external connector to the terminal or have any suitable construction for receiving a fiber optic cable into the cavity of the terminal.

Although the array of connection ports 16 is configured as having two rows, embodiments are not limited thereto. A single row or more than two rows of connection ports 16 may be provided.

Although, these concepts are described with respect to fiber optic terminals configured as multiports, the concepts may be used with any other suitable terminal such as closures, network interface devices, wireless devices, distribution point unit or other suitable devices.

In some embodiments, the connection ports 16 of the fiber optic terminal 10 may have a push-and-retain connection without the use of threaded coupling nuts or quick turn bayonets for securing the external connectors. This allows for fiber optic terminals with connection ports that are closely spaced together and may result in relatively small fiber optic terminals since the room needed for turning a threaded coupling nut or bayonet is not necessary. The compact form-factors may allow the placement of the terminals in tight spaces in indoor, outdoor, buried, aerial, industrial or other applications while providing at least one connection port that is advantageous for a robust and reliable optical connection in a removable and replaceable manner. The disclosed fiber optic terminals may also be aesthetically pleasing and provide organization for the optical connectors in manner that the prior art terminals cannot provide. However, the external fiber optic connectors may be secured to the terminal using conventional structures such as threads, bayonets or other suitable mating geometry for attaching to the connector ports of the terminal.

Fiber optic terminals disclosed herein may also have a dense spacing of connection ports for receiving external optical connectors if desired or not. The fiber optic terminals disclosed herein advantageously allow a relatively dense and organized array of connection ports in a relatively small form-factor while still being rugged for demanding environments; however fiber optic terminals of any size or shape are possible using the concepts disclosed. As optical networks increase densifications and space is at a premium, the robust and small-form factors for devices such as fiber optic terminals disclosed and depicted herein becomes increasingly desirable for network operators.

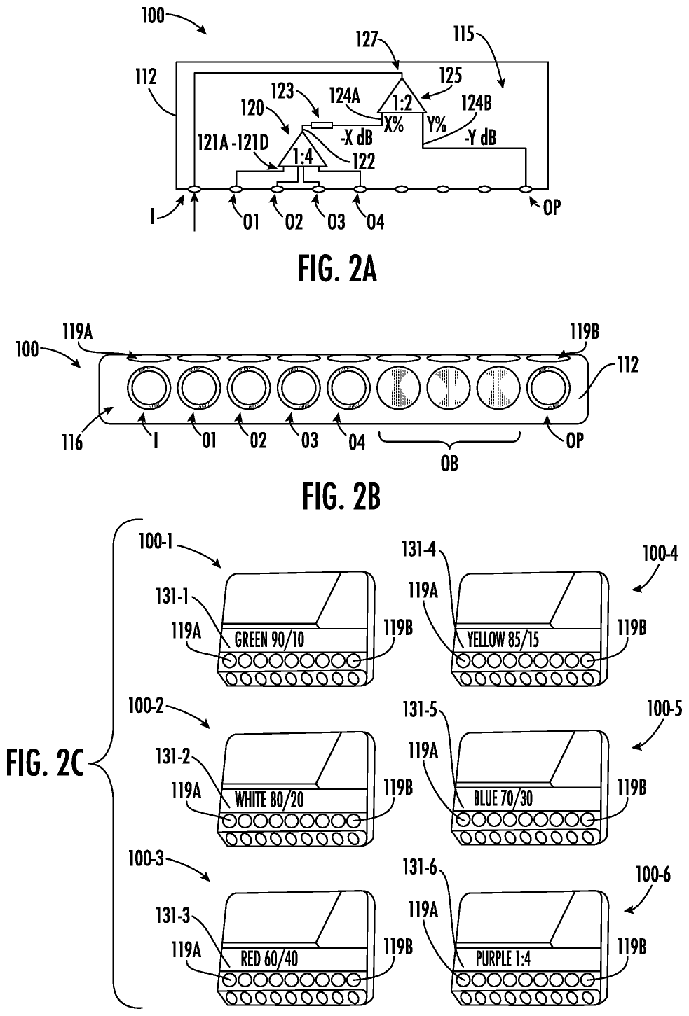

Referring now to FIGS. 2A and 2B, an example fiber optic terminal 100 is illustrated. FIG. 2A schematically illustrates internal components of the fiber optic terminal 100 while FIG. 2B illustrates an outer surface of an edge of the fiber optic terminal 100 that provides a plurality of connection ports 116. As shown in FIG. 2A, the fiber optic terminal 100 includes a shell 112 that defines an internal cavity 115 in which the internal components of the fiber optic terminal 100 are disposed.

An input connection port I is provided at an end of the array of connection ports 116 and is operable to receive an input connector. The input connection port I is optically coupled to an optical input 127 of a first splitter device 126 disposed within the cavity 115. Any of the optical components within the cavity 115 may be optically coupled by any method such as, without limitation, an optical fiber and a waveguide within a substrate. (e.g., a planar lightwave circuit) As used herein, the term “optically coupled” means that two components are capable of passing optical signals there between.

The first splitter device 126 is configured to split an incoming input optical signal into two optical signals. One of the two optical signals is a first splitter optical output signal at a splitter optical output 124A and the other is a pass-through optical output signal at a pass-through optical output 124B. In some embodiments, an optical power of the splitter optical output signal and the pass-through optical output signal are substantially equal. However, in daisy-chain optical networks, the first splitter device 126 is an asymmetric splitter in that the optical power of the splitter optical output signal and the optical power of the pass-through optical output signal are different.

Thus, splitter devices having different splitting ratios are used to split the input optical signal (i.e., X %/Y %). For example, first splitter devices in a daisy-chain may have 90%/10% (i.e., 10% of the signal provided to a plurality of subscribers by way of the splitter optical output and 90% provided to the next fiber optic terminal by way of the pass-through optical output), 80%/20%, 70%/30%, and 60%/40% splitting ratios.

The pass-through optical output 124B of the first splitter device 126 is optically coupled to a pass-through output connection port OP at the edge of the shell 112 within the array of connection ports 116, which may receive a fiber optic connector to connect the fiber optic terminal to another downstream fiber optic terminal in a daisy-chain network.

The splitter optical output 124A is optically coupled to an input 122 of a second splitter device 120. The second splitter 120 device splits the splitter optical output signal of provided by the first splitter device 126 into a plurality of output signals that are each then routed to a plurality of subscribers. The plurality of output signals are provided at a plurality of second optical outputs 121A-121D of the second splitter device 120.

The second splitter device 120 is an N×M optical splitter, where N<M. In the illustrated example, the second splitter device 120 is a 1×4 optical splitter configured to provide connectivity to four subscribers. The second optical outputs 121A-121D of the second splitter device 120 are optically coupled to output connection ports O1, O2, O3, and O4, respectively. As shown in FIG. 2B, the output connection ports O1-O4 are provided in the connection port array 116 at an edge of the shell 112. The shell 212 may be labeled to indicate the output connection port number for each output connection port. In the illustrated example, three unused blank connection ports OB are provided. However, it should be understood that in other embodiments there are no blank connection ports.

The input connection port I is provided at a first end of the connection port array 116 (e.g., the left end) and the pass-through output connection port OP is provided at an opposite end (e.g., the right end) to make it easy for the craft to locate the respective ports as needed. In some embodiments the input connection port I and the pass-through output connection port OP are labeled with dedicated colors so that the craft may readily identify the connection ports. As a non-limiting example, the input connection port I may have a color red associated therewith and the pass-through output connection port OP may have a blue color associated therewith. For example, the colored markings may be provided on a top or bottom surface of the shell 112 proximate the input connection port I and the pass-through output connection port OP. In the illustrated embodiment, a first marking 119A having a first color (e.g., red) is positioned on a top surface of the shell 112 above the input connection port I, and a second marking 119B having a second color (e.g., blue) is positioned on the top surface of the shell 112 above the pass-through output connection port OP.

The fiber optic terminal 100 may be provided in a plurality of different split ratios to provide the daisy-chained network. The percentage of the optical power of the pass-through optical signal decreases the further downstream the fiber optical terminal 100 is positioned from the main transmission optical fiber. For example, a first fiber optical terminal in the daisy-chained network may have a 10%/90% optical power split ratio and a last fiber optic terminal in the daisy-chained network may have a 60%/40% optical power split ratio.

In some embodiments, the fiber optic terminals are marked to visually indicate the optical power split ratio to the craft to avoid installation of an incorrect optical power split ratio in the daisy-changed network.

FIG. 2C illustrates six example fiber optic terminals 100-1-100-6 each having a different optical power split ratio. A first fiber optic terminal 100-1 may have an optical power split ratio of 90%/10%, which may be clearly indicated by a marking 131-1 that is colored (e.g., green) and also includes the specific optical power split ratio. A second fiber optic terminal 100-2 may have an optical power split ratio of 80%/20%, which may be clearly indicated by a marking 131-2 that is colored (e.g., white) and also includes the specific optical power split ratio. A third fiber optic terminal 100-3 may have an optical power split ratio of 60%/40%, which may be clearly indicated by a marking 131-3 that is colored (e.g., red) and also includes the specific optical power split ratio. A fourth fiber optic terminal 100-4 may have an optical power split ratio of 65%/15%, which may be clearly indicated by a marking 131-2 that is colored (e.g., yellow) and also includes the specific optical power split ratio. A fifth fiber optic terminal 100-5 may have an optical power split ratio of 70%/30%, which may be clearly indicated by a marking 131-5 that is colored (e.g., blue) and also includes the specific optical power split ratio. A sixth fiber optic terminal 100-6 may have an optical power split ratio of 1:4, which may be clearly indicated by a marking 131-6 that is colored (e.g., purple) and also includes the specific optical power split ratio. It should be understood that other optical power split ratios may be provided, and that other than six different fiber optic terminals may be provided. Additionally, markings 119A, 119B are provided to indicate the input connection port I and the pass-through output connection port OP, respectively.

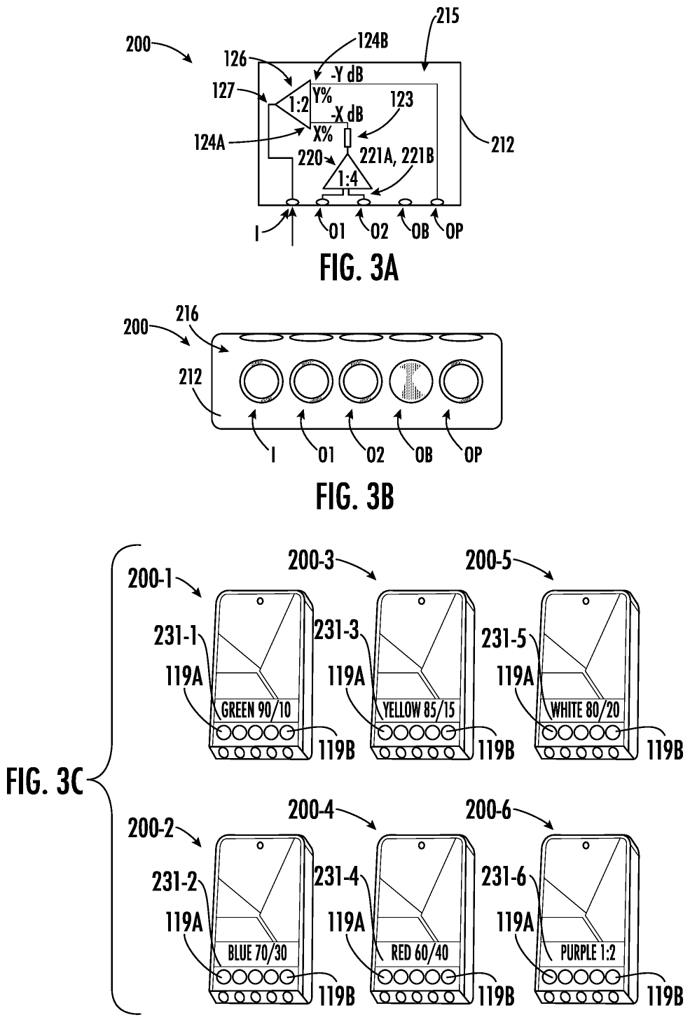

Referring now to FIGS. 3A and 3B, an example two output fiber optic terminal 200 is illustrated. FIG. 3A schematically illustrates internal components of the fiber optic terminal 200 while FIG. 3B illustrates an outer surface of an edge of the fiber optic terminal 200 that provides a plurality of connection ports 216 (five connection ports in this example). As shown in FIG. 3A, the fiber optic terminal 200 includes a shell 212 that defines an internal cavity 215 in which the internal components of the fiber optic terminal 100 are disposed.

An input connection port I is provided at an end of the array of connection ports 216 and is operable to receive an input connector. The input connection port I is optically coupled to an optical input 127 of a first splitter device 126 disposed within the cavity 215. Any of the optical components within the cavity 215 may be optically coupled by any method such as, without limitation, an optical fiber and a waveguide within a substrate.

As described with respect to FIGS. 2A and 2B, the first splitter device 126 is configured to split an incoming input optical signal into two optical signals. One of the two optical signals is a first splitter optical output signal at a splitter optical output 124A and the other is a pass-through optical output signal at a pass-through optical output 124B.

The pass-through optical output 124B of the first splitter device 126 is optically coupled to a pass-through output connection port OP at the edge of the shell 212 within the array of connection ports 216, which may receive a fiber optic connector to connect the fiber optic terminal to another downstream fiber optic terminal in a daisy-chain network.

The splitter optical output 124A is optically coupled to an input 222 of a second splitter device 220. The second splitter 220 device splits the splitter optical output signal of provided by the first splitter device 126 into two output signals that are each then routed to at least two subscribers. The two output signals are provided at second optical outputs 221A and 221B of the second splitter device 220.

The second optical outputs 221A, 221B of the second splitter device 220 are optically coupled to output connection ports O1 and O2, respectively. As shown in FIG. 3B, the output connection ports O1 and O2 are provided in the connection port array 216 at an edge of the shell 212. The shell 212 may be labeled to indicate the output connection port number for each output connection port. In the illustrated example, one unused blank connection port OB is provided. However, it should be understood that in other embodiments there are no blank connection ports.

The input connection port I is provided at a first end of the connection port array 216 (e.g., the left end) and the pass-through output connection port OP is provided at an opposite end (e.g., the right end) to make it easy for the craft to locate the respective ports as needed. In some embodiments the input connection port I and the pass-through output connection port OP are labeled with a dedicated color so that the craft may readily identify the connection ports. As a non-limiting example, the input connection port I may have a color red associated therewith and the pass-through output connection port OP may have a blue color associated therewith. For example, the colored markings may be provided on a top or bottom surface of the shell 212 proximate the input connection port I and the pass-through output connection port OP. In the illustrated embodiment, a first marking 119A having a first color (e.g., red) is positioned on a top surface of the shell 212 above the input connection port I, and a second marking 119B having a second color (e.g., blue) is positioned on the top surface of the shell 212 above the pass-through output connection port OP.

FIG. 3C illustrates six example fiber optic terminals 200-1-200-6 each having a different optical power split ratio. A first fiber optic terminal 200-1 may have an optical power split ratio of 90%/10%, which may be clearly indicated by a marking 231-1 that is colored (e.g., green) and also includes the specific optical power split ratio. A second fiber optic terminal 200-2 may have an optical power split ratio of 80%/20%, which may be clearly indicated by a marking 231-2 that is colored (e.g., white) and also includes the specific optical power split ratio. A third fiber optic terminal 200-3 may have an optical power split ratio of 60%/40%, which may be clearly indicated by a marking 231-3 that is colored (e.g., red) and also includes the specific optical power split ratio. A fourth fiber optic terminal 200-4 may have an optical power split ratio of 65%/15%, which may be clearly indicated by a marking 231-2 that is colored (e.g., yellow) and also includes the specific optical power split ratio. A fifth fiber optic terminal 200-5 may have an optical power split ratio of 70%/30%, which may be clearly indicated by a marking 231-5 that is colored (e.g., blue) and also includes the specific optical power split ratio. A sixth fiber optic terminal 200-6 may have an optical power split ratio of 1:4, which may be clearly indicated by a marking 231-6 that is colored (e.g., purple) and also includes the specific optical power split ratio. It should be understood that other optical power split ratios may be provided, and that other than six different fiber optic terminals may be provided. Additionally, markings 119A, 119B are provided to indicate the input connection port I and the pass-through output connection port OP, respectively.

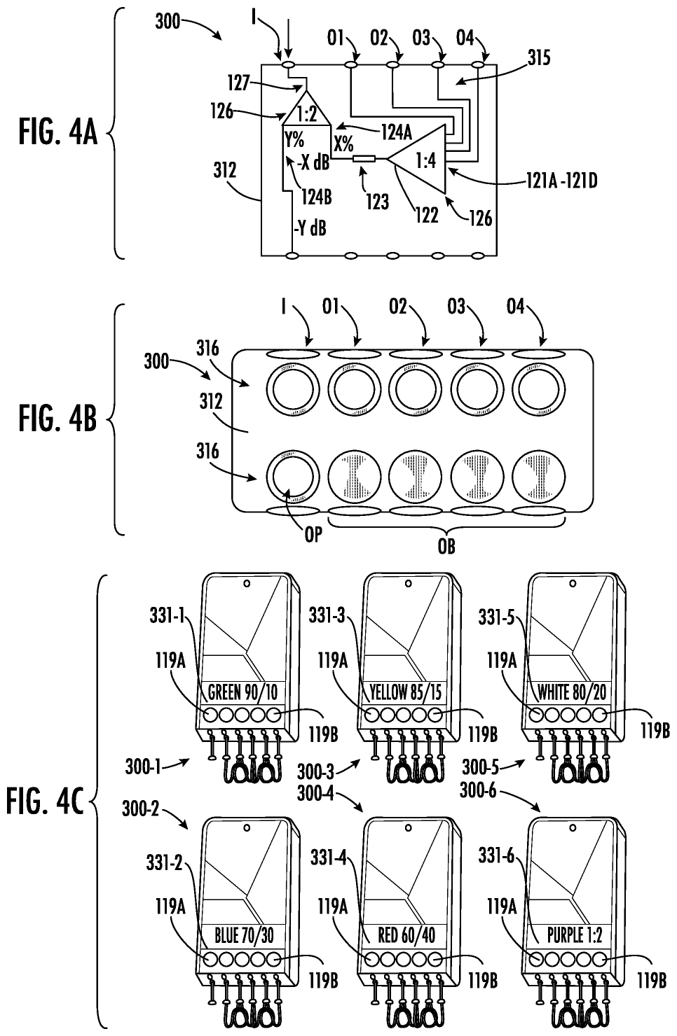

Referring now to FIGS. 4A and 4B, another example four output fiber optic terminal 300 is illustrated. The fiber optic terminal 300 of FIGS. 4A and 4B is similar to the fiber optic terminal 100 of FIGS. 2A and 2B except that the body 312 provides a two-row array of connection ports 316. Each row has five connection ports 316. The input connection port I and the pass-through output connection port OP are vertically aligned with one another in two separate rows of the array (e.g., on the left side), making it easy for the craft to locate the connection port I and the pass-through output connection port OP when installing the fiber optic terminal in the field. In the illustrated embodiment, one row of connection ports 316 does not include any output ports while the other row includes all of the output connection ports O1-O4. In other embodiments, output ports may be provided in both rows of connection ports 316.

FIG. 4C illustrates six example fiber optic terminals 300-1-300-6 each having a different optical power split ratio. A first fiber optic terminal 300-1 may have an optical power split ratio of 90%/10%, which may be clearly indicated by a marking 331-1 that is colored (e.g., green) and also includes the specific optical power split ratio. A second fiber optic terminal 300-2 may have an optical power split ratio of 80%/20%, which may be clearly indicated by a marking 331-2 that is colored (e.g., white) and also includes the specific optical power split ratio. A third fiber optic terminal 300-3 may have an optical power split ratio of 60%/40%, which may be clearly indicated by a marking 331-3 that is colored (e.g., red) and also includes the specific optical power split ratio. A fourth fiber optic terminal 300-4 may have an optical power split ratio of 65%/15%, which may be clearly indicated by a marking 331-2 that is colored (e.g., yellow) and also includes the specific optical power split ratio. A fifth fiber optic terminal 300-5 may have an optical power split ratio of 70%/30%, which may be clearly indicated by a marking 331-5 that is colored (e.g., blue) and also includes the specific optical power split ratio. A sixth fiber optic terminal 300-6 may have an optical power split ratio of 1:4, which may be clearly indicated by a marking 331-6 that is colored (e.g., purple) and also includes the specific optical power split ratio. It should be understood that other optical power split ratios may be provided, and that other than six different fiber optic terminals may be provided. Additionally, markings 119A, 119B are provided to indicate the input connection port I and the pass-through output connection port OP, respectively.

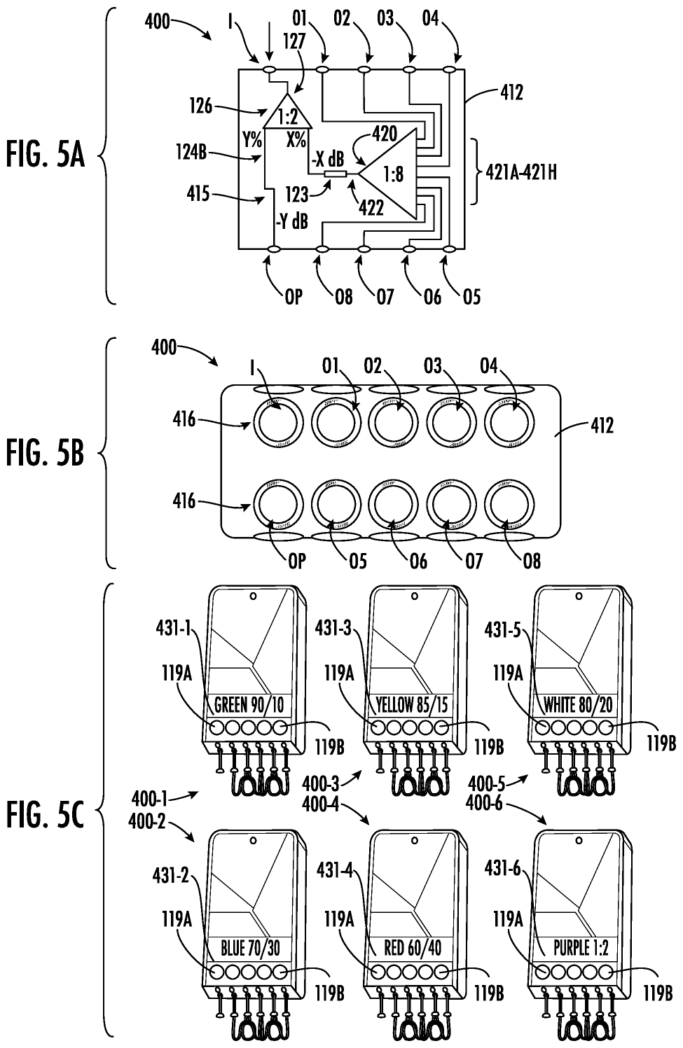

Referring now to FIGS. 5A and 5B, an example eight output fiber optic terminal 400 is illustrated. FIG. 5A schematically illustrates internal components of the fiber optic terminal 400 while FIG. 5B illustrates an outer surface of an edge of the fiber optic terminal that provides a plurality of connection ports 416. In the present example, eight connection ports 416 are provided in an array defined by two rows. As shown in FIG. 5A, the fiber optic terminal 400 includes a shell 412 that defines an internal cavity 415 in which the internal components of the fiber optic terminal 400 are disposed.

An input connection port I is provided at an end of the array of connection ports 216 and is operable to receive an input connector. The input connection port I is optically coupled to an optical input 127 of a first splitter device 126 disposed within the cavity 415. Any of the optical components within the cavity 415 may be optically coupled by any method such as, without limitation, an optical fiber and a waveguide within a substrate.

As described with respect to FIGS. 5A and 5B, the first splitter device 126 is configured to split an incoming input optical signal into two optical signals. One of the two optical signals is a first splitter optical output signal at a splitter optical output 124A and the other is a pass-through optical output signal at a pass-through optical output 124B.

The pass-through optical output 124B of the first splitter device 126 is optically coupled to a pass-through output connection port OP at the edge of the shell 412 within the array of connection ports 416, which may receive a fiber optic connector to connect the fiber optic terminal to another downstream fiber optic terminal in a daisy-chain network.

The splitter optical output 124A is optically coupled to an input 422 of a second splitter device 420. The second splitter 420 device splits the splitter optical output signal of provided by the first splitter device 126 into eight output signals that are each then routed to at least eight subscribers. The eight output signals are provided at second optical outputs 421A-421H of the second splitter device 420.

The second optical outputs 421A-421H of the second splitter device 420 are optically coupled to output connection ports O1-08, respectively. As shown in FIG. 3B, the output connection ports O1-08 are provided in the connection port array 416 at an edge of the shell 412. The shell 412 may be labeled to indicate the output connection port number for each output connection port.

The input connection port I is provided at a first end of the connection port array 216 (e.g., the left end) in a first row and the pass-through output connection port OP is provided at the same end in a second row to make it easy for the craft to locate the respective ports as needed. In some embodiments the input connection port I and the pass-through output connection port OP are labeled with a dedicated color so that the craft may readily identify the connection ports. As a non-limiting example, the input connection port I may have a color red associated therewith and the pass-through output connection port OP may have a blue color associated therewith. For example, the colored markings may be provided on a top or bottom surface of the shell 412 proximate the input connection port I and the pass-through output connection port OP. In the illustrated embodiment, a first marking 119A having a first color (e.g., red) is positioned on a top surface of the shell 412 above the input connection port I, and a second marking 119B having a second color (e.g., blue) is positioned on the bottom surface of the shell 412 above the pass-through output connection port OP.

FIG. 5C illustrates six example fiber optic terminals 400-1-400-6 each having a different optical power split ratio. A first fiber optic terminal 400-1 may have an optical power split ratio of 90%/10%, which may be clearly indicated by a marking 431-1 that is colored (e.g., green) and also includes the specific optical power split ratio. A second fiber optic terminal 400-2 may have an optical power split ratio of 80%/20%, which may be clearly indicated by a marking 431-2 that is colored (e.g., white) and also includes the specific optical power split ratio. A third fiber optic terminal 400-3 may have an optical power split ratio of 60%/40%, which may be clearly indicated by a marking 431-3 that is colored (e.g., red) and also includes the specific optical power split ratio. A fourth fiber optic terminal 400-4 may have an optical power split ratio of 65%/15%, which may be clearly indicated by a marking 431-2 that is colored (e.g., yellow) and also includes the specific optical power split ratio. A fifth fiber optic terminal 400-5 may have an optical power split ratio of 70%/30%, which may be clearly indicated by a marking 431-5 that is colored (e.g., blue) and also includes the specific optical power split ratio. A sixth fiber optic terminal 400-6 may have an optical power split ratio of 1:4, which may be clearly indicated by a marking 431-6 that is colored (e.g., purple) and also includes the specific optical power split ratio. It should be understood that other optical power split ratios may be provided, and that other than six different fiber optic terminals may be provided. Additionally, markings 119A, 119B are provided to indicate the input connection port I and the pass-through output connection port OP, respectively.

The fiber optic terminals described herein may also employ wavelength division multiplexing in lieu of, or in addition to, optical signal splitting. Wavelength division multiplexing devices may receive as input an input optical signal (i.e., a common demultiplex signal) having a plurality of wavelengths, and output a plurality of output signals within a plurality of wavelength bands. Wavelength division multiplexing devices may also receive as inputs a plurality of input optical signals within a plurality of wavelength bands that are converted into a multi-wavelength output signal that allows subscribers to upload data.

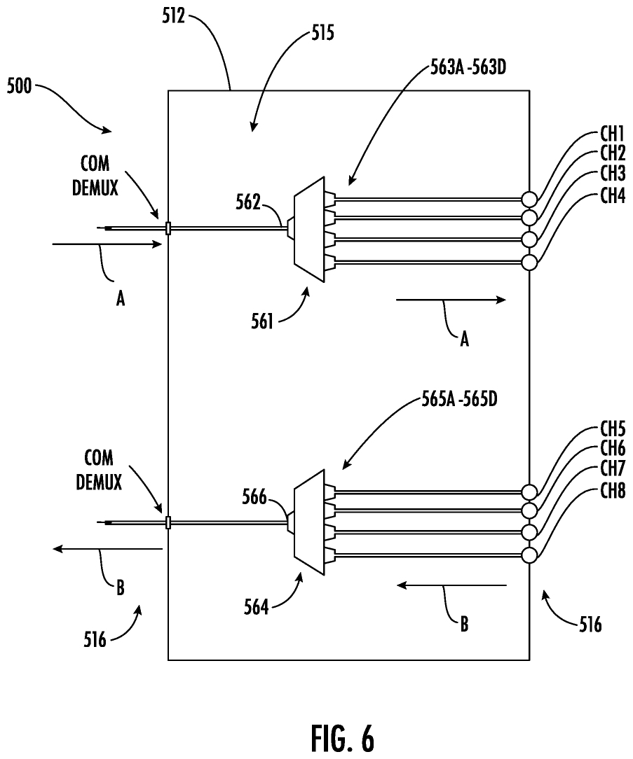

Referring to FIG. 6, an example fiber optic terminal 500 having a shell 512 and push-button connection ports 512 as described above. The small size of the shell 512 of the fiber optic terminal 500 allows it to be used in any location within the optical fiber network.

The example fiber optic terminal 500 comprises a wavelength division demultiplexer device 561 and a wavelength division multiplexer device 564. The wavelength division demultiplexer device 561 is provided so that subscribers may download data in the direction indicated by arrows A, while the wavelength division multiplexer device 564 is provided so that subscribers may upload data in the direction indicated by arrows B.

The wavelength division demultiplexer device 561 comprises a demultiplexer input 562 and a plurality of demultiplexer outputs 563A-563D. The demultiplexer input is optically coupled to a common demultiplexer connection port (COM DEMUX) provided at an edge of the shell 512. The plurality of demultiplexer outputs 563A-563D is optically coupled to a plurality of output channel connection ports Ch1, Ch2, Ch3, and Ch4 at the edge of the shell 512. An input optical signal having a plurality of wavelengths is received at the common demultiplexer connection port COM DEMUX. The wavelength division demultiplexer device 561 splits the input optical signal into a plurality of output optical signals each having a wavelength within a wavelength band at the plurality of output channel connection ports Ch1, Ch2, Ch3, and Ch4 at the edge of the shell 512.

The wavelength division multiplexer device 564 comprises a plurality of multiplexer inputs 565A-565D and a multiplexed output 566. The plurality of multiplexer inputs 565A-565D is coupled to a plurality of input channel connection ports Ch 5, Ch 6, Ch 7, and Ch 8 provided at the edge of the shell 512. The multiplexed output 566 is optically coupled to a common multiplexer connection port (COM MUX) provided at the edge of the shell 512. Upload optical signals from subscribers may be received at the plurality of input channel connection ports Ch 5, Ch 6, Ch 7, and Ch 8 and multiplexed by the multiplexer device 564 into a multiplexed output signal that is provided at the common multiplexer connection port COM MUX.

In some embodiments, only one multiplexer/demultiplexer device is provided such that optical signals travel in both directions A and B through the multiplexer/demultiplexer device and respective waveguides and optical fibers. In such embodiments, the plurality of wavelengths propagating in one direction (e.g., the A direction) is different from the plurality of wavelengths propagating in the other direction (e.g., the B direction). Thus, optical signal generation devices (e.g., lasers) may be provided at the subscriber end-points to provide optical signals in the B direction.

Any number of connection ports and any number of wavelengths may be utilized. Further, coarse wavelength division multiplexing, (CWDM) dense wavelength division multiplexing (DWDM) or any other multiplexing methodology may be employed. Table 1 below illustrates various configurations for coarse wavelength division multiplexing using a 2×4 fiber optic terminal.

TABLE 1

| | CWDM | CWDM | CWDM | CWDM | CWDM | CWDM |
|---|---|---|---|---|---|---|
| | 4 channel | 4 channel | 4 channel | 4 channel | 8 channel | 8 channel |
| Port | (high) | (low) | (high) | (low) | (low) | (high) |
| Config: | Mux and Dmux | Mux and Dmux | Mux and Dmux | Mux and Dmux | Mux OR Dmux | Mux OR Dmux |
| 1 | Common Dmux | Common Dmux | Common Dmux | Common Dmux | Common | Common |
| 2 | 1551 Dmux | 1471 Dmux | 1351 Dmux | 1271 Dmux | 1271 | 1471 |
| 3 | 1571 Dmux | 1491 Dmux | 1371 Dmux | 1291 Dmux | 1291 | 1491 |
| 4 | 1591 Dmux | 1511 Dmux | 1431 Dmux | 1311 Dmux | 1311 | 1511 |
| 5 | 1611 Dmux | 1531 Dmux | 1451 Dmux | 1331 Dmux | 1331 | 1531 |
| 6 | Common Mux | Common Mux | Common Mux | Common Mux | Upgrade | Upgrade (or 1310) |
| 7 | 1551 Mux | 1471 Mux | 1351 Mux | 1271 Mux | 1351 | 1551 |
| 8 | 1571 Mux | 1491 Mux | 1371 Mux | 1291 Mux | 1371 | 1571 |
| 9 | 1591 Mux | 1511 Mux | 1431 Mux | 1311 Mux | 1431 | 1591 |
| 10 | 1611 Mux | 1531 Mux | 1451 Mux | 1331 Mux | 1451 | 1611 |

Table 1 above illustrates the common multiplex ports and the common demultiplex ports, as well as the wavelength for each of the output and input channels. Some configurations may provide for an upgrade port or expansion port that may be used to couple two or more fiber optic terminals together. In such configurations, an upgrade or an expansion port may be used as an input into a second fiber optic terminal.

Table 2 below illustrates various configurations in a 2×8 fiber optic terminal.

TABLE 2

| | CWDM | CWDM | CWDM | CWDM | |
|---|---|---|---|---|---|
| | 4 channel (high | 4 channel (high | 4 channel (low | 4 channel (low | CWDM |
| | a) | b) | a) | b) | 16 channel |
| Port Config: | Mux and Dmux | Mux and Dmux | Mux and Dmux | Mux and Dmux | Mux OR Dmux |
| 1 | Common | Common | Common | Common | Common |
| | Dmux | Dmux | Dmux | Dmux | |
| 2 | 1551 Dmux | 1471 Dmux | 1351 Dmux | 1271 Dmux | 1271 |
| 3 | 1571 Dmux | 1491 Dmux | 1371 Dmux | 1291 Dmux | 1291 |
| 4 | 1591 Dmux | 1511 Dmux | 1431 Dmux | 1311 Dmux | 1311 |
| 5 | 1611 Dmux | 1531 Dmux | 1451 Dmux | 1331 Dmux | 1331 |
| 6 | Upgrade (or | Upgrade (or | Upgrade (or | Upgrade | 1351 |
| | 1310) | 1310) | 1310) | | |
| 7 | | | | | 1371 |
| 8 | | | | | 1431 |
| 9 | | | | | 1451 |
| 10 | Common Mux | Common Mux | Common Mux | Common Mux | Test |
| 11 | 1551 Mux | 1471 Mux | 1351 Mux | 1271 Mux | 1471 |
| 12 | 1571 Mux | 1491 Mux | 1371 Mux | 1291 Mux | 1491 |
| 13 | 1591 Mux | 1511 Mux | 1431 Mux | 1311 Mux | 1511 |
| 14 | 1611 Mux | 1531 Mux | 1451 Mux | 1331 Mux | 1531 |
| 15 | Upgrade (or | Upgrade (or | Upgrade (or | Upgrade | 1551 |
| | 1310) | 1310) | 1310) | | |
| 16 | | | | | 1571 |
| 17 | | | | | 1591 |
| 18 | | | | | 1611 |

It should be understood that configurations for DWDM may also be employed.

FIG. 7 illustrates the edges of a first fiber optic terminal 500-1 and a second fiber optic terminal 500-2 daisy-chained together by providing an upgrade connection port E/U of a plurality of connection ports 516 to a common connection port (i.e., a common multiplexer connection port or a common demultiplexer connection port). In this manner, the number of channels of the first fiber optic terminal 500-1 are expanded by including the second fiber optic terminal 500-2.

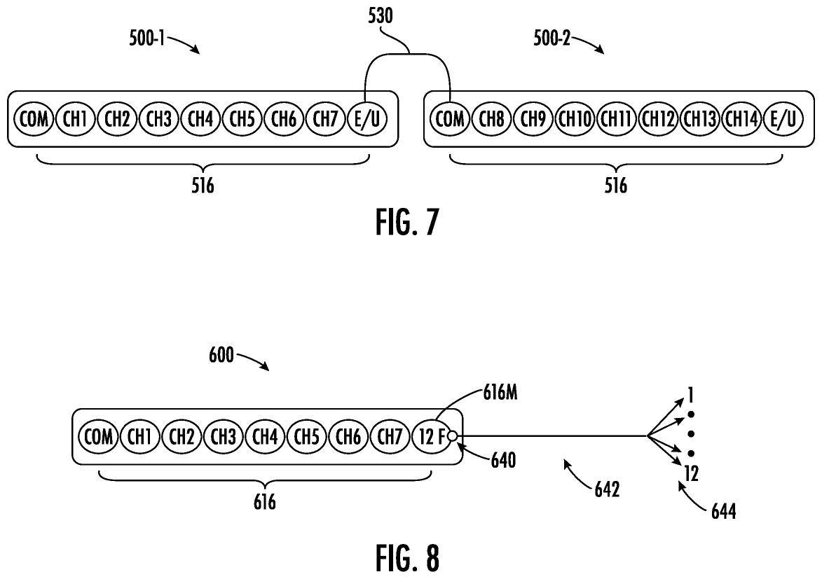

Referring now to FIG. 8, an edge of a fiber optic terminal 600 having a plurality of connection ports 616 is illustrated. A multifiber connection port 616M is provided that is configured to receive a multifiber connector 640. Thus, one port provides multiple output and/or input optical fibers. As a non-limiting example, the multifiber connection port 616M may be configured to receive an OptiTip® multifiber optical connector manufactured by Corning Optical Communications. The multifiber connector 640 may be a component of an optical tether assembly 642 having a plurality of legs that are provided to a plurality of subscribers, for example. It should be understood that more than one of the connection ports 516 may be multifiber connection ports in some embodiments.

The multifiber connection port 616M receives optical signals that are either multiplexed by wavelength division multiplexing or split by a 1×M optical splitter device. In one example, the fiber optic terminal 600 includes a 1×M optical splitter device that receives as input an output from another 1×M optical splitter device. For example, referring to FIG. 2A, splitter output 121A may be provided as an input to another splitter device (not shown) prior to the first output connection port O1 that provides multiple waveguides/optical fibers at the first output connection port O1. In another example, a wavelength division demultiplexer device (not shown) may be disposed between a splitter output and an output connection port such that the optical signal at the splitter output is demultiplex into a plurality of output optical signals each having a particular wavelength or wavelength band.

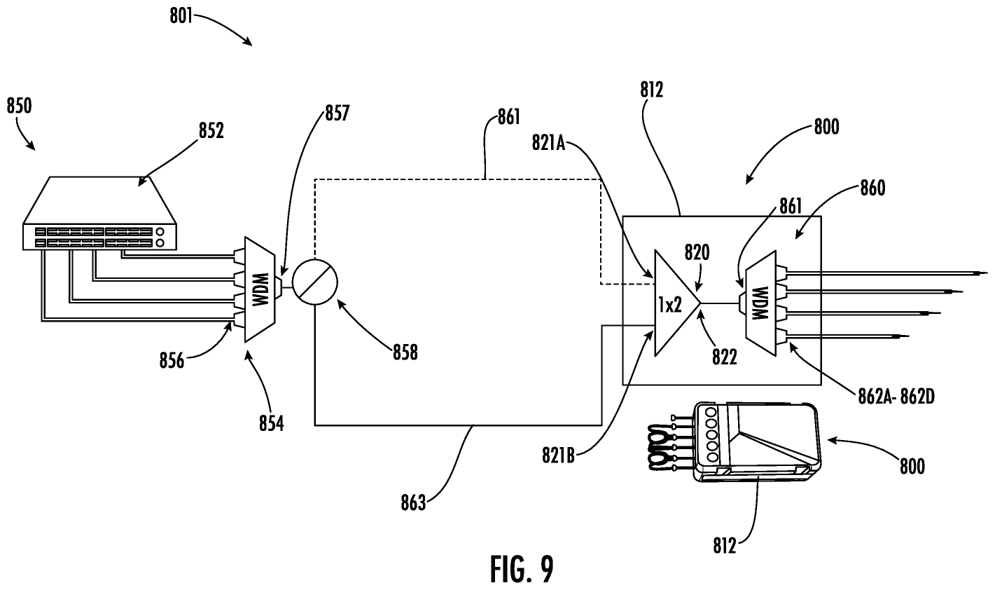

Additional configurations of the fiber optic terminal including both a splitter device and a wavelength division multiplexer/demultiplexer device. Referring now to FIG. 9, an optical communications network 801 is schematically illustrated. An optical communications network device 850 (e.g., a switch) provided at a central office or other location produces a plurality of optical signals each having a different wavelength. The optical communications network device 850 is optically coupled to a wavelength division multiplexer device 854 at a plurality of inputs 856. The wavelength division multiplexer device 854 produces a multiplexed output signal at a multiplexer output 567 that is optically coupled to a fiber network switch 858. The optical communications network 801 includes a primary fiber network 861 and a secondary, backup fiber network 863. The secondary, backup fiber network 863 may be utilized if the primary fiber network 861 fails for whatever reason. The fiber network switch 858, which may also be provided at the central office or other location, may be any optical device capable of selecting either the primary fiber network 861 or the secondary, backup fiber network 636. As a non-limiting example, the fiber network switch 858 may be an optical ring resonator.

The optical communications network 801 further includes a fiber optical terminal 800 having a shell 812 such as described above. Within a cavity of the shell there is disposed an optical coupler 820 and a wavelength division demultiplexer device 860. The optical coupler 820 comprises a first input 821A that is optically coupled to the primary fiber network 861 at a first input connection port, and a second input 821B that is optically coupled to the secondary, backup fiber network 636 at a second input connection port. The optical coupler 820 includes an output 822 that is optically coupled to an input 861 of the wavelength division demultiplexer device 860. The wavelength division demultiplexer device 860 demultiplexes the input optical signal on either the primary fiber network 861 or the secondary, backup fiber network 636 into a plurality of output optical signals at a plurality of demultiplexer outputs 862A-862D. The plurality of output optical signals may have the same wavelengths as the plurality of optical signals produced by the optical communications network device 850. The plurality of output optical signals may then be provided to a plurality of subscribers, for example.

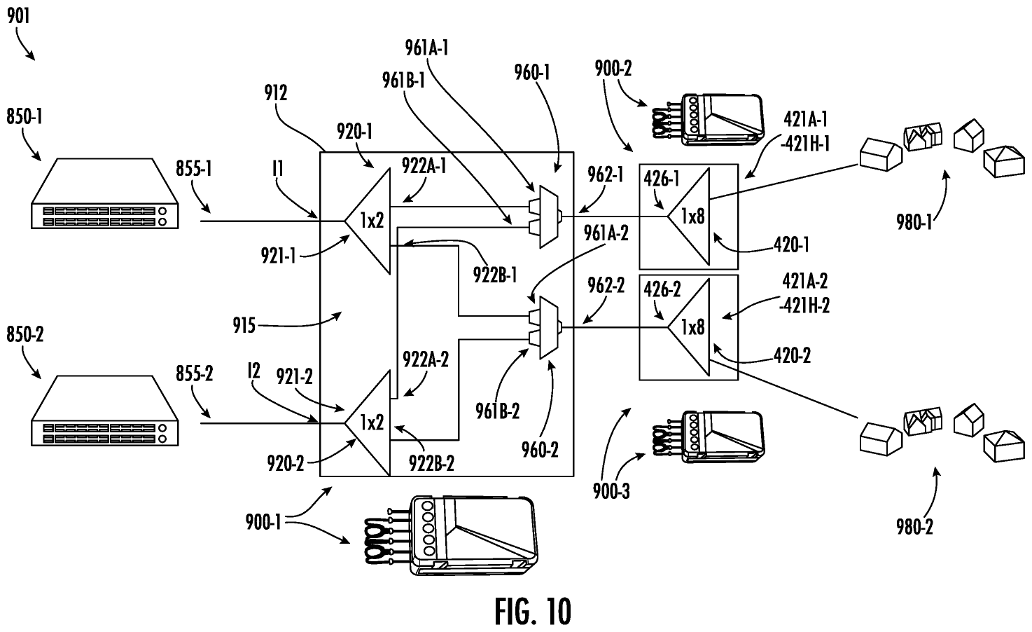

FIG. 10 illustrates an optical communications network 901 that utilizes a fiber optic terminal 900-1 having both first and second splitter devices 920-1, 920-2. The optical communications network 901 includes two sub-networks provided by two different communications technologies. The fiber optic terminal 900-1 may be used to on-board a newer communications technology without requiring the installation of additional optical fiber. For example, a first optical communications network device 850-1 may be configured to produce one or more optical signals according to an older communications technology. As a non-limiting example, the first optical communications network device 850-1 may be configured as an XGS-PON device configured to communicate using the XGS-PON telecommunications standard. The second optical communications network device 850-2 may be configured to produce one or more optical signals according to a newer communications technology. As a non-limiting example, the second optical communications network device 850-2 may be configured as an NG-PON2 device configured to communicate using the NG-PON2 telecommunications standard. The fiber optic terminal 900-1 allows both telecommunications technologies to operate simultaneously in the same optical communications network 901.

Optical signals according to a first telecommunications technology propagate within first optical fiber 855-1, and optical signals according to a second telecommunications technology propagate within optical fiber 855-2. The fiber optic terminal comprises a shell 912 defining a cavity 915. The first optical fiber 855-1 is provided to a first input connection port I1 at an edge of the shell 912 by a connector and the second optical fiber 855-2 is provided to a second optical fiber connection port I2 at the edge of the shell 912 by a connector.

A first splitter device 920-1 and a second splitter device 920-1 are disposed within the cavity 915. The first splitter device 920-1 includes an input 921-1, a first output 922A-1, and a second output 922B-1. The second splitter device 920-2 includes an input 921-2, a first output 922A-2, and a second output 922B-2. The input 921-1 of the first splitter device 920-1 is optically coupled to the first input connection port I1. The input 921-2 of the second splitter device 920-2 is optically coupled to the second input connection port I2.

A first wavelength division multiplexer device 960-1 and a second wavelength division multiplexer device 960-2 are also disposed within the cavity. The first wavelength division multiplexer device 960-1 includes a first multiplexer input 961A-1, a second multiplexer input 961B-1, and a multiplexer output 962-1. The second wavelength division multiplexer device 960-2 includes first multiplexer input 961A-2, a second multiplexer input 961B-2, and a multiplexer output 962-2.

The first output 922A-1 of the first splitter device 920-1 is optically coupled to the first multiplexer input 921A-1 of the first wavelength division multiplexer device 960-1, and the first output 922A-2 of the second splitter device 920-2 is optically coupled to the second multiplexer input 921B-1 of the first wavelength division multiplexer device 960-1. Thus, the first wavelength division multiplexer device 960-1 receives optical signals from both the first splitter device 920-1 and the second splitter device 920-2 and thus both communications technologies.

The second output 922B-1 of the first splitter device 920-1 is optically coupled to the first multiplexer input 921A-2 of the second wavelength division multiplexer device 960-2, and the second output 922B-2 of the second splitter device 920-2 is optically coupled to the second multiplexer input 961B-2 of the second wavelength division multiplexer device 960-2. Thus, the second wavelength division multiplexer device 960-2 receives optical signals from both the first splitter device 920-1 and the second splitter device 920-2 and thus both communications technologies.

Both the first multiplexer device 920-1 and the second multiplexer device 920-2 multiplex optical signals of both communications technologies (which have different wavelengths) into two output optical signals provided at the multiplexer outputs 962-1, 962-2 of the first and second wavelength division multiplexer devices 960-1, 960-2, respectively. In the illustrated embodiment, the multiplexer output 962-1 of the first wavelength division multiplexer device 960-1 is optically coupled to an input port of a second fiber optic terminal 900-2.

The second fiber optic terminal 900-2 may include a shell in be configured as the other fiber optic terminals described herein. The second fiber optic terminal 900-2 includes a third splitter device 402-1 configured as an 1×8 optical splitter that splits the incoming optical signal at an input 422-1 into eight output optical signals that are provided at eight outputs 421A-1-421H-1. It should be understood that the third splitter device 402-1 may be configured as any 1×M optical splitter. The eight outputs are optically coupled to eight output connection ports that may receive fiber optic connectors that provide the split optical signal to a first set of subscribers 980-1. Which communications technology each subscriber receives depends on a filter or demultiplexer that is installed at the subscriber.

The multiplexer output 962-2 of the second wavelength division multiplexer device 960-2 is optically coupled to an input port of a third fiber optic terminal 900-3.

The third fiber optic terminal 900-3 may include a shell in be configured as the other fiber optic terminals described herein. The third fiber optic terminal 900-3 includes a fourth splitter device 402-2 configured as an 1×8 optical splitter that splits the incoming optical signal at an input 422-2 into eight output optical signals that are provided at eight outputs 421A-2-421H-2. The eight outputs are optically coupled to eight output connection ports that may receive fiber optic connectors that provide the split optical signal to a second set of subscribers 980-2. Which communications technology each subscriber receives depends on a filter or demultiplexer that is installed at the subscriber.

Thus, the example optical communications network 901 allows at least two communication technologies to be communicated across a single network. This provides the advantage of upgrading a subscriber's service without requiring new optical fiber and also provides the advantage of allowing legacy equipment to operate.

It should be understood that other configurations for the optical communications network 901 of FIG. 10 are possible. For example, both the second fiber optic terminal 900-2 and the third fiber optic terminal 900-3 may be combined into a single fiber optic terminal. Further, the first fiber optic terminal 900-1, the second fiber optic terminal 900-2, and the third fiber optic terminal 900-3 may be combined into a single fiber optic terminal in some embodiments.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A fiber optic terminal comprising:
a shell comprising a cavity;
an input connection port comprising a port opening extending from an outer surface of the shell into the cavity;
a pass-through output connection port comprising a port opening extending from the outer surface of the shell into the cavity; and
at least two output connection ports comprising a port opening extending from the outer surface of the shell into the cavity,
wherein:
the input connection port, the at least two output connection ports, and the pass-through output connection port are arranged in an array at an edge of the shell; and
the fiber optic terminal is configured such that an optical power at the pass-through output connection port is greater than an optical power of the at least two output connection ports.

2. The fiber optic terminal of claim 1, wherein:
the input connection port is positioned at a first end of the array; and
the pass-through output connection port is positioned at a second end of the array that is opposite from the first end of the array.

3. The fiber optic terminal of claim 1, wherein the array comprises a single row.

4. The fiber optic terminal of claim 1, wherein the array comprises a first row and a second row.

5. The fiber optic terminal of claim 4, wherein the input connection port is positioned in the first row of the array and the pass-through output connection port is positioned in the second row of the array.

6. The fiber optic terminal of claim 5, wherein the input connection port and the pass-through output connection port are in the same column of the array.

7. The fiber optic terminal of claim 1, wherein:
the input connection port is labeled with a first color on the shell, the at least two output connection ports are labeled with a second color on the shell, and the pass-through output connection port is labeled with a third color on the shell; and
the first color, the second color and the third color are different colors.

8. A fiber optic terminal comprising:
a shell comprising a cavity;
an input connection port comprising a port opening extending from an outer surface of the shell into the cavity;
a first splitter device comprising:
a first optical input configured to be optically coupled to an input optical connector inserted into the input connection port; and
a splitter optical output and a pass-through optical output, wherein the first splitter device splits an input optical signal received at the first optical input into a first splitter optical output signal at the splitter optical output and a pass-through optical output signal at the pass-through optical output;
a second splitter device comprising:
a second optical input optically coupled to the splitter optical output of the first splitter device;
at least two second optical outputs, wherein the second splitter devices splits the first splitter optical signal into at least two second optical output signals at the at least two second optical outputs;
a pass-through output connection port comprising a port opening extending from the outer surface of the shell into the cavity and optically coupled to the pass-through optical output of the first splitter device, wherein the pass-through optical output of the first splitter device is configured to be optically coupled to a pass-through connector inserted into the pass-through output connection port; and
at least two output connection ports comprising a port opening extending from the outer surface of the shell into the cavity and optically coupled to the at least two second optical outputs of the second splitter device, wherein the at least two second optical outputs are configured to be optically coupled to at least two output connectors inserted into the at least two output connection ports,
wherein the input connection port, the at least two output connection ports, and the pass-through output connection port are arranged in an array at an edge of the shell.

9. The fiber optic terminal of claim 8, wherein:
the input connection port is positioned at a first end of the array; and
the pass-through output connection port is positioned at a second end of the array that is opposite from the first end of the array.

10. The fiber optic terminal of claim 8, wherein:
the input connection port is positioned at a first end of the array; and
the pass-through output connection port is positioned at a second end of the array that is opposite from the first end of the array.

11. The fiber optic terminal of claim 8, wherein the array comprises a single row.

12. The fiber optic terminal of claim 8, wherein the array comprises a first row and a second row.

13. The fiber optic terminal of claim 12, wherein the input connection port is positioned in the first row of the array and the pass-through output connection port is positioned in the second row of the array.

14. The fiber optic terminal of claim 13, wherein the input connection port and the pass-through output connection port are in the same column of the array.

15. The fiber optic terminal of claim 8, wherein:
the input connection port is labeled with a first color on the shell, the at least two output connection ports are labeled with a second color on the shell, and the pass-through output connection port is labeled with a third color on the shell; and
the first color, the second color and the third color are different colors.

16. A fiber optic terminal comprising:
a shell comprising a cavity;
a first input connection port and a second input connection port, wherein each of the first input connection port and the second input connection port comprise a port opening extending from an outer surface of the shell into the cavity;
an optical coupler within the cavity comprising a first input operable to receive a first optical signal from the first input connection port, and a second input operable to receive a second optical signal from the second input connection port;
a wavelength division demultiplexer device within the cavity comprising a demultiplexer input that is optically coupled to the coupler output of the optical coupler, and at least two demultiplexer outputs, wherein each of the at least two demultiplexer outputs is configured to pass an output optical signal in a different wavelength band than the other of the at least two demultiplexer outputs; and
at least two output connection ports comprising a port opening extending from the outer surface of the shell into the cavity, wherein the at least two output connection ports receive at least two output optical signals from the wavelength division demultiplexer device.

17. The fiber optic terminal of claim 16, wherein the first input connection port, the second input connection port, and the at least two output connection ports are arranged in an array at an edge of the shell.

18. The fiber optic terminal of claim 16, wherein the array comprises a single row.

19. The fiber optic terminal of claim 17, wherein the array comprises a first row and a second row.

20. The fiber optic terminal of claim 16, wherein the at least two demultiplexer outputs comprises four multiplexer outputs.

21. A fiber optic terminal comprising:
a shell comprising a cavity;
at least two input connection ports comprising a port opening extending from an outer surface of the shell into the cavity;
at least two splitters within the cavity and each configured to split an input optical signal received at the at least two input connection ports;
at least two wavelength division multiplexer devices within the cavity and each configured to receive output optical signals from the at least two splitters and multiplex the output optical signals into at least two multiplexed output optical signals; and
at least two output connection ports comprising a port opening extending from the outer surface of the shell into the cavity, wherein the at least two output connection ports receive the least two multiplexed output optical signals.

22. The fiber optic terminal of claim 21, wherein the input connection port and the at least two output connection ports are arranged in an array at an edge of the shell.

23. The fiber optic terminal of claim 22, wherein the array comprises a single row.

24. The fiber optic terminal of claim 22, wherein the array comprises a first row and a second row.

25. A fiber optic terminal comprising:
a shell comprising a cavity;
a first input connection port and a second input connection port, wherein each of the first input connection port and the second input connection port comprise a port opening extending from an outer surface of the shell into the cavity;
a first splitter and a second splitter within the cavity, wherein each of the first splitter and the second splitter comprises an input, a first splitter output, and a second splitter output;
a first wavelength division multiplexer device and a second wavelength division multiplexer device within the cavity, wherein each of the first and second wavelength division multiplexer devices comprises a first multiplexer input, a second multiplexer input, and a multiplexer output; and
at least two output connection ports comprising a port opening extending from the outer surface of the shell into the cavity, wherein:
the at least two output connection ports receive at least two output optical signals from the first and second wavelength division multiplexer devices;
the first splitter output of the first splitter is optically coupled to the first multiplexer input of the first wavelength division multiplexer device;
the second splitter output of the first splitter is optically coupled to the first multiplexer input of the second wavelength division multiplexer device;
the first splitter output of the second splitter is optically coupled to the second multiplexer input of the first wavelength division multiplexer device; and
the second splitter output of the second splitter is optically coupled to the second multiplexer input of the second wavelength division multiplexer device.

26. The fiber optic terminal of claim 25, wherein the input connection port and the at least two output connection ports are arranged in an array at an edge of the shell.

27. The fiber optic terminal of claim 26, wherein the array comprises a single row.

28. The fiber optic terminal of claim 26, wherein the array comprises a first row and a second row.

29. A fiber optic terminal comprising:
a shell comprising a cavity;
a common demultiplexer connection port comprising a port opening extending from an outer surface of the shell into the cavity;
a wavelength division demultiplexer device comprising a demultiplexer input and a plurality of demultiplexer outputs, wherein the demultiplexer input is optically coupled to the common demultiplexer connection port;
a plurality of output channel connection ports, wherein:
each output channel connection port comprises a port opening extending from the outer surface of the shell into the cavity, and the plurality of output channel connection ports is optically coupled to the plurality of demultiplexer outputs; and
the common demultiplexer connection port and the plurality of output channel connection ports are arranged in an array at an edge of the shell.

30. The fiber optic terminal of claim 29, further comprising a demultiplexer upgrade port.

31. The fiber optic terminal of claim 29, further comprising a multifiber connection port for receiving a multifiber connector.

32. The fiber optic terminal of claim 31, wherein:
the multifiber connection port comprises a plurality of waveguides; and
each fiber of the multifiber connection port propagates an optical signal in a wavelength band that is different from remaining fibers of the multi-fiber port.

33. The fiber optic terminal of claim 31, wherein:
the multifiber connection port comprises a plurality of waveguides; and
the plurality of waveguides of the multifiber port propagate optical signals within the same wavelength band.

34. The fiber optic terminal of claim 33, further comprising at least one optical coupler comprising a coupler input that is optically coupled to one demultiplexer output of the plurality of demultiplexer outputs, wherein a plurality of coupler outputs are optical coupled to the plurality of waveguides.

35. The fiber optic terminal of claim 29, further comprising:
a common multiplexer connection port comprising a port opening extending from the outer surface of the shell into the cavity;
a wavelength division multiplexer device comprising a plurality of multiplexer inputs and a multiplexer output, wherein the multiplexer output is optically coupled to the common multiplexer connection port;
a plurality of input channel connection ports, wherein:
each input channel connection port comprises a port opening extending from the outer surface of the shell into the cavity, and the plurality of input channel connection ports is optically coupled to the plurality of multiplexer inputs; and
the common multiplexer connection port and the plurality of input channel connection ports are arranged in the array at the edge of the shell.
